(19) United States
(12) Patent Application Publication
(10) Pub. No.: US 2015/0062807 A1
(43) Pub. Date: Mar. 5, 2015

(54) COMPUTING DEVICE COVER

(71) Applicants: Paul Gwin, Orangevale, CA (US); Mark Sprenger, Folsom, CA (US)

(72) Inventors: Paul Gwin, Orangevale, CA (US); Mark Sprenger, Folsom, CA (US)

(21) Appl. No.: 14/014,763

(22) Filed: Aug. 30, 2013

(51) Int. Cl. G06F 1/16

(52) U.S. Cl. CPC G06F 1/1656
USPC 361/679.55; 29/428

(57) ABSTRACT

Techniques for modifying forming a top cover and bottom cover of a computing device are described herein. The techniques include a method including forming a bottom cover of a computing device having protrusions, and forming a top cover of the computing device having recesses, the top cover recesses to receive the bottom cover protrusions.

### TECHNICAL FIELD

This disclosure relates generally to techniques for forming a cover of a computing device. More specifically, the disclosure describes techniques for increasing platform stiffness with protrusions and recesses in the cover of a computing device.

### BACKGROUND

With the fast growth of computing devices, lighter, thinner computing devices are increasingly preferred by users. Platform stiffness may affect usability, reliability, and perceived quality while also preventing stress of various components.

### BRIEF DESCRIPTION OF DRAWINGS

FIG. 1 is a diagram of a computing device illustrating torsional twisting.

FIG. 2 is a top view of protrusions and recesses of computing device covers.

FIGS. 3A-3C are top views of protrusions and recesses in various shapes.

FIG. 4 is a peripheral view of a bottom cover and a top cover being coupled by the protrusions and recesses of each.

FIG. 5 is a bar graph illustrating an increase of torsional stiffness due to the protrusions and recesses of the bottom and top covers.

FIG. 6 is a block diagram illustrating a method of forming a bottom cover and a top cover with protrusions and recesses to increase platform stiffness.

### DETAILED DESCRIPTION

The subject matter disclosed herein relates to techniques for increasing platform stiffness. A computing device may be configured having a bottom cover and a top cover. The bottom cover may include protrusions received at recesses of the top cover. In the embodiments described herein, a top cover and a bottom cover may be interleaved by the protrusions and recesses of the top and bottom covers, thereby increasing platform stiffness. Method and systems related to increasing stiffness of the platform of the computing device, while avoiding an increase of mass of the platform is described herein.

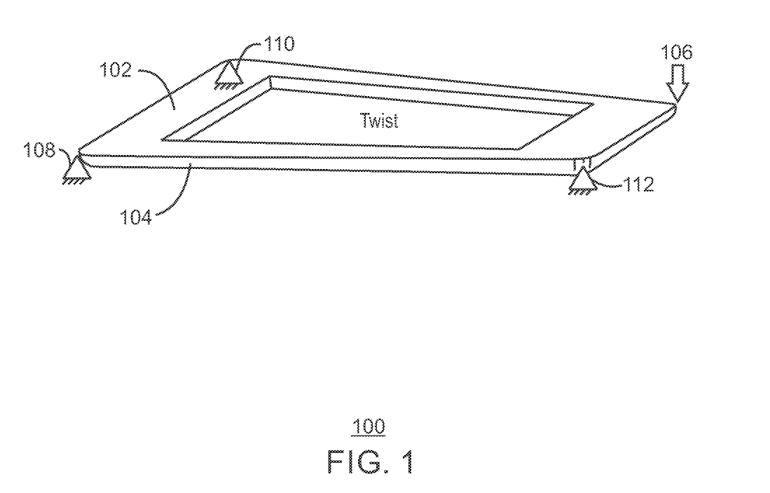

FIG. 1 is a diagram of a computing device illustrating torsional twisting. The computing device 100 includes a top cover 102 and a bottom cover 104. The computing device may include corners. In some scenarios, force may be applied to one corner as illustrated by the arrow 106, while other corners may be held stable as illustrated by the triangles 108, 110, and 112. In this scenario, the computing device may experience twisting, or torsional stress. In some cases, torsional stress may cause the top cover 102 to slide in relation to the bottom cover 104. A computing device that is more easily twisted may be unreliable in terms of component operation, usability, and perceived quality. The embodiments described herein include a computing device platform with increased stiffness such that the platform resists torsional stress. Further, the embodiments described herein include an apparatus for increasing torsional stiffness without requiring an increase in the number of screws used to hold the covers of the computing device together.

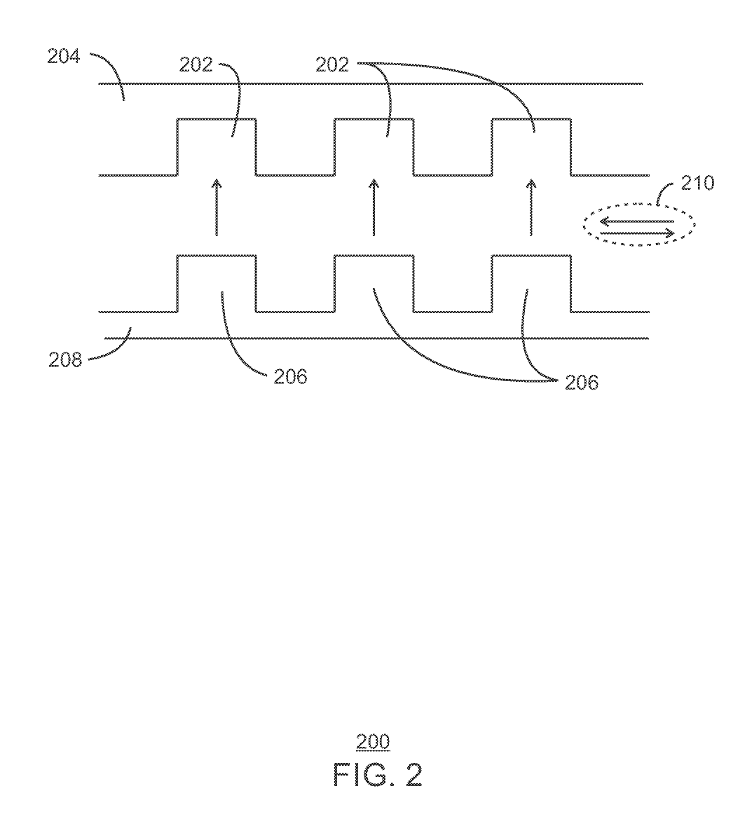

FIG. 2 is a top view of protrusions and recesses of computing device covers. As illustrated in FIG. 2, the recesses 202 of a top cover 204 may be configured to receive the protrusions 206 of the bottom cover 208. The recesses 202 and the protrusions 206 are a slide reduction mechanism configured to reduce sliding between the top cover 204 and the bottom cover 208.

The protrusions 206 are formed as a pattern along the periphery of a first portion, such as the bottom cover 208, of the computing device. A “pattern,” as referred to herein, is a series of protrusions extending along the periphery of a portion, such as the bottom cover 208. In embodiments, the pattern is implemented at the bottom cover 208, and a mirrored pattern is implemented as recesses of the top cover 204. In embodiments, the recesses may be disposed on the bottom cover 208 while the protrusions are disposed on the top cover 204, rather than protrusions being exclusively at the bottom cover 208 and recesses exclusively at the top cover 204.

A “cover,” as referred to herein, is a component of a computing device configured to house other components of a computing device such as a processing device, a memory device, a storage device, and the like. A cover may be an outer housing, such as an outer skin. In embodiments, a cover may be a sub-frame, such as a chassis, configured as a platform sub-structure upon which other components of the computing device may be housed or attached. For example, the top cover 204 of FIG. 2 may be a sub-frame configured to be coupled to a display, such as a touchscreen of a tablet computer. As another example, the bottom cover 208 may be a component configured to house a tablet computer.

In some embodiments, the protrusions 206 of the bottom cover 208 include at least two 90 degree angle transitions as illustrated in FIG. 2. The protrusions 206 are configured to be received at the recesses 202 of the top cover 204, and the recesses 202 include at least two 90 degree angle transitions to receive the protrusions 206 of the bottom cover 208. In embodiments, the 90 degree angle transitions of each of the protrusions 206 and the recesses 202 prevent sliding as indicated by the arrows in the dashed circle 210 between the bottom cover 208 and the top cover 204. The reception of the protrusions 206 at the recesses 202 may increase shear load capacity between the top cover 204 and the bottom cover 208.

The “shear load capacity,” as referred to herein, is the strength of a material or component against a type of yield where the material or component fails in shear due to a shear load. A shear load is a force that tends to produce a sliding failure on a material along a plane that is parallel to the direction of the force. For example, a shear load may be placed on the bottom cover 208 when a user holds the computing device by one corner resulting in a shear load being between the bottom cover 208 and the top cover 204. The 90 degree angles of the recesses 202 and the protrusions 206 may reduce sliding 210 between the top cover 204 and the bottom cover 208 when the protrusions 206 are received at the recesses 202. In embodiments, the increase of shear load capacity reduces relatively sliding between the top cover 204 and the bottom cover 208 and results in an increase of overall torsional stiffness of the computing device.

Although the protrusions 206 and the recesses 202 are illustrated in FIG. 2 as being rectangular in shape, the protrusions 206 and recesses 202 may be implemented as shapes other than rectangular. For example, the protrusions 206 and recesses 202 may be trapezoidal, oval, semi-circular, or any other suitable shape such that shear load capacity is increased between the bottom cover 206 and the top cover 202.

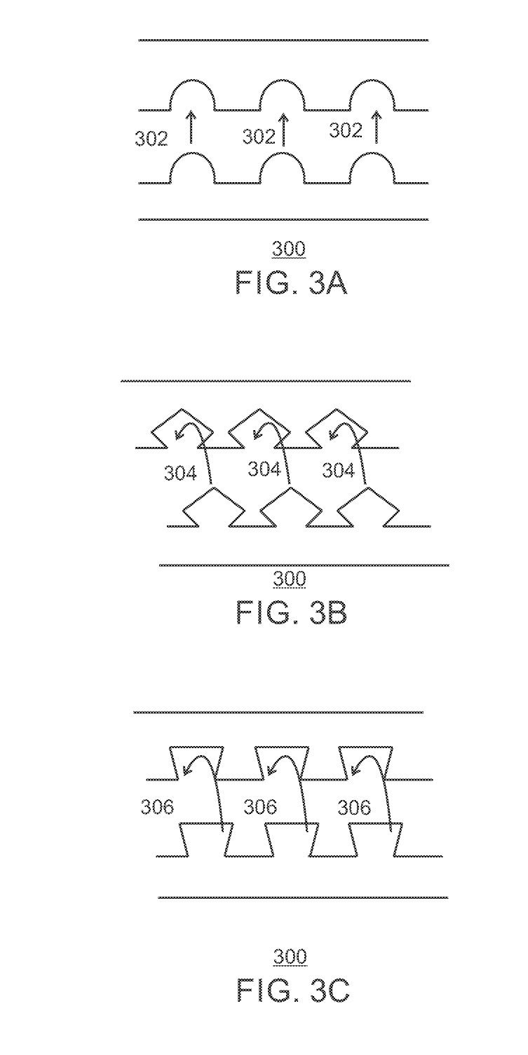

FIGS. 3A-3C are top views of protrusions and recesses of in various shapes. FIG. 3A illustrates that the protrusions 206 may be semi-circular shape and received by recesses 202 as indicated by the arrows 302. FIG. 3B illustrates that the protrusions 206 may be semi-diamond shape and received by the recesses 202 as indicated by the arrows 304. FIG. 3C illustrates that the protrusions 206 may be semi-trapezoidal in shape and received by recesses 202 as indicated by the arrows 306. Other shapes not illustrated in FIGS. 3A-3C may be implemented so long as sliding between the bottom cover and the top cover is reduced when the protrusions 208 are received by the recesses 208.

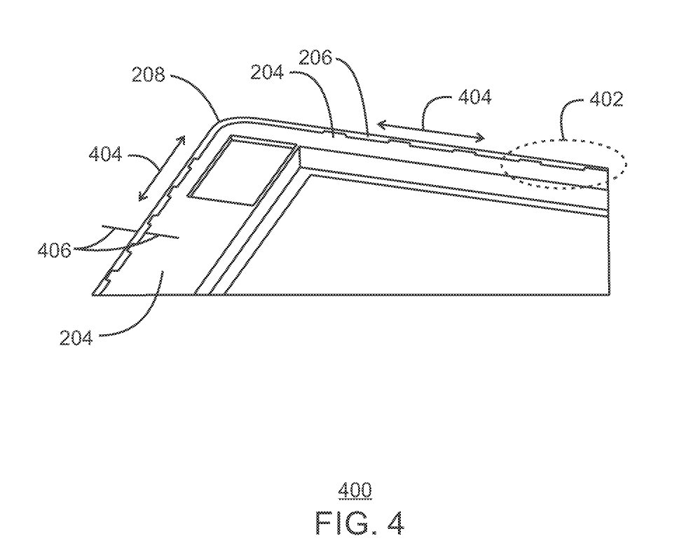

FIG. 4 is a peripheral view of a bottom cover and a top cover being coupled by the protrusions and recesses of each. As illustrated in FIG. 4, the protrusions 208 of the bottom cover 208 may be received by the recesses 202 of the top cover 204 as indicated by the dashed circle 402. The protrusions 208 received by the recesses 202 reduce sliding of the bottom cover with respect to the top cover, as indicated by the arrows 404.

In embodiments, the bottom cover 208 may include side walls. As illustrated in FIG. 4, the protrusions of the bottom cover 208 may be disposed perpendicular to the side walls of the bottom cover 208. Although FIG. 4 illustrates that the protrusions of the bottom cover are formed perpendicular to the side walls of the bottom cover 208, the protrusions may be in line with the side walls and extend vertically from the periphery of the side walls of the bottom cover 208.

In embodiments, the top cover 204 may be a sub-frame, or an intermediate structural member behind a front cover of the computing device as discussed above in reference to FIG. 2. The sub-frame of the top cover 204 may be configured to receive additional components such as a display of an all-in-one (AIO) device. An AIO device, as referred to herein, is a computing device configured to house a display as well as computing components including a processor within a housing. The top cover 204 and bottom cover 208 may be components of an AIO device housing. The embodiments described herein may be implemented as a form factor reference design (FFRD). For example, the protrusions of a bottom cover being received at recesses of a top cover may be implemented in a tablet computing device as a FFRD implementation.

The protrusions and recesses may be large enough to provide an increased torsional stiffness. In embodiments, the increase of torsional stiffness may be a function of the size of the protrusion from the bottom cover 206. For example, the protrusion of the bottom cover 208 may be 2.5 millimeters as indicated by 406 in FIG. 4. Likewise, the recess of the top cover 202 may be at least 2.5 millimeters such that it may receive a protrusion of 2.5 millimeters.

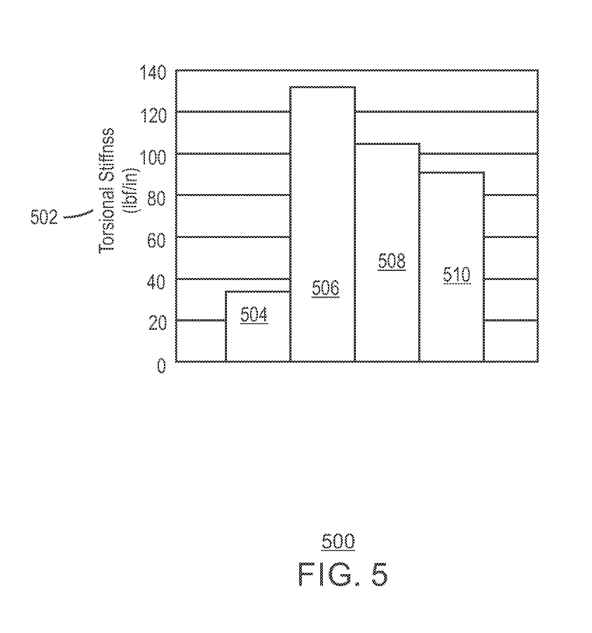

FIG. 5 is a bar graph illustrating an increase of torsional stiffness due to the protrusions and recesses of the bottom and top covers. As discussed above in reference to FIG. 2, the increase of shear load capacity between the top cover 204 and the bottom cover 208 may result in overall torsional stiffness of the computing device. The bar graph 500 of FIG. 5 illustrates an increase of torsional stiffness 502 in different implementations of the embodiments discussed herein. Bar 504 shows a torsional stiffness of less than 40 pounds force per inch (lbf/in) when the top cover and bottom cover do not include protrusions and recesses as discussed above in reference to FIGS. 2 and 3. Bar 506 shows that the torsional stiffness increases to greater than 120 lbf/in when the top cover and bottom cover do include the protrusions and recesses, relative to the device represented by bar 504. Bar 508 shows that the torsional stiffness is still above 100 lbf/in when the top cover and bottom cover include protrusions and recesses, even when the thickness of the top cover is reduced to around 1 millimeter thick from more than 2 millimeters thick. Bar 510, the torsional stiffness is less than 100 lbf/in, yet still more than 80 lbf/in when the top and bottom cover include protrusions and recesses, and even when thickness of the bottom cover is reduced to around 1 millimeter thick the top cover reduced from 2 millimeters thick to 0.5 mm thick. Therefore, a device implementing the techniques described herein may be relatively lighter than a device that does not implement the techniques.

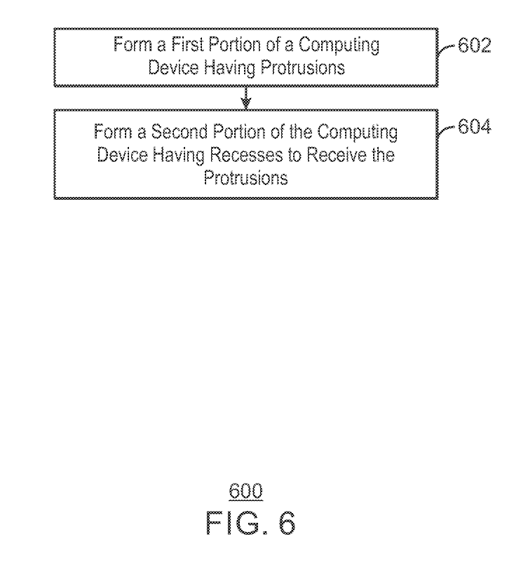

FIG. 6 is a block diagram illustrating a method of forming a bottom cover and a top cover with protrusions and recesses to increase platform stiffness. At block 602, a first portion of a computing device is formed. The protrusions are formed as a pattern along the periphery of the first portion. In embodiments, the first portion is a bottom cover of the computing device. The protrusions may be formed along the periphery of the bottom cover and received at recesses of a second portion, such as a top cover of the computing device. At block 604, a second portion is formed having recesses configured to receive the protrusions of the bottom cover. As discussed above, the second portion may be a top cover and the recesses of the top cover may be configured to receive the protrusions of the bottom cover.

As discusses above, the protrusions are formed along the periphery of the bottom cover. For example, the bottom cover may include a side wall and the protrusions may be formed perpendicular to the side wall of the bottom cover, and at a periphery of the bottom cover. In embodiments, the protrusions may be formed extending vertically from the side wall of the bottom cover.

Each protrusion and corresponding recess may be referred to herein as a stiffening element. The torsional stiffness of the computing device may be a function of the number of stiffening elements included in the cover. For example, a bottom cover having only 1 protrusion every 5 inches may result in a relatively less stiff platform for a computing device than a bottom cover having 2 protrusions every 5 inches. By forming the top and bottom covers to include a simple repeating pattern of recesses and protrusions, a large number of stiffening elements may be incorporated into the cover at relatively low cost. For example, in some embodiments, the cover may include 8, 16, 32, 64 or more stiffening elements. In some embodiments, the protrusions and recesses may slide together vertically, radially, or other direction sufficient to prevent sliding between the top cover and the bottom cover. In some embodiments, the techniques described herein enable insertion of interlocking features in a radial motion while a vertical motion (separating bottom from top) is constrained. Thus, a panel may be inserted with interlocking tabs, snapped in place, and very difficult to remove. The techniques described herein may be implemented as a security/tamper proof design where a chassis may be desired to have some level of tamper resistance.

In some embodiments, when the angles of protrusions and recesses are normal to the direction of sliding between the top cover and bottom cover then a radial force and a force, such as a camming action, that separates the top and bottom covers vertically may result. Thus, the techniques described herein include bearing surfaces of each of the recesses and/or protrusions are normal to the sliding direction, or with an angle that produces a force that pulls the covers together, as illustrated in FIGS. 3B and 3C.

In embodiments, the protrusions and the recesses are formed having at least two 90 degree angle transitions each. The 90 degree angle transitions may be useful in preventing sliding between the top cover and the bottom cover. Other angles are contemplated by the embodiments discussed herein, and are not limited to 90 degree angle transitions. For example, the protrusions and recesses may include transitions that are more or less than 90 degrees such that sliding between the top cover and the bottom cover is reduced.

### EXAMPLE 1

A method of forming covers of a computing device is described herein. The method may include forming a first portion of a computing device having protrusions, the protrusions formed as a pattern along the periphery of the first portion. A second portion may be formed. The second portion may be formed having recesses to receive the protrusions of the first portion.

### EXAMPLE 2

An apparatus is described herein. The apparatus may include a first portion of a computing device. The first portion includes protrusions formed as a pattern along the periphery of the first portion. The first portion may be a covering means, such as a bottom cover of the computing device, and the apparatus may include a second portion of the computing device, the second portion having recesses to receive the protrusions. Thus, the second portion may be a covering means, such as a top cover of the computing device. The top cover may, in some cases, be configured with recesses to receive the protrusions of the bottom covering means.

### EXAMPLE 3

A computing device is described herein. The computing device may include protrusions at a side wall of a first portion of the computing device. For example, the protrusions may extend perpendicularly from a side wall of a bottom covering means. The protrusions are formed as a pattern along the periphery of the first portion. The computing device may include recesses of a second portion of the computing device, the recesses to receive the protrusion of the first portion. For example, the recesses may be in a covering means, or in a sub-frame of the computing device, and may be configured to receive the protrusions extending from the periphery of the first portion, such as the bottom cover.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A method, comprising:
forming a first portion of a computing device having protrusions, the protrusions formed as a pattern along the periphery of the first portion; and
forming a second portion of the computing device having recesses to receive the protrusions.

2. The method of claim 1, wherein the first portion is a bottom cover of the computing device and the second portion is a top cover of the computing device.

3. The method of claim 2, wherein the top cover is a sub-frame of the computing device.

4. The method of claim 1, wherein the protrusions are formed comprising at least two 90 degree angle transitions, and wherein the recesses are formed comprising at least two 90 degree angle transitions, such that a protrusion having at least two 90 degree angle transitions may be received at a recess having at least two 90 degree angle transitions.

5. The method of claim 1, wherein the first portion is a bottom cover of the computing device and the second portion is a top cover of the computing device, wherein the bottom cover comprises side walls, and wherein the protrusions of the bottom cover are disposed perpendicular to the side wall.

6. The method of claim 5, wherein the protrusions of the bottom cover disposed perpendicular to the side wall are to be received by the recesses of the top cover.

7. The method of claim 1, wherein the computing device is an all-in-one (AIO) computing device.

8. The method of claim 1, wherein reception of the protrusions at the recesses increase shear load capacity between the first portion and the second portion.

9. An apparatus, comprising:
a first portion of a computing device, the first portion having protrusions, the protrusions formed as a pattern along the periphery of the first portion; and
a second portion of the computing device, the second portion having recesses to receive the protrusions.

10. The apparatus of claim 9, wherein the first portion is a bottom cover of the computing device and the second portion is a top cover of the computing device.

11. The apparatus of claim 10, wherein the top cover is a sub-frame of the computing device.

12. The apparatus of claim 9, wherein the protrusions comprise at least two 90 degree angle transitions, and wherein the recesses comprise at least two 90 degree angle transitions, such that a protrusion having at least two 90 degree angle transitions may be received at a recess having at least two 90 degree angle transitions.

13. The apparatus of claim 9, wherein the first portion is a bottom cover of the computing device and the second portion is a top cover of the computing device, wherein the bottom cover comprises side walls, and wherein the protrusions of the bottom cover are disposed perpendicular to the side wall.

14. The apparatus of claim 13, wherein the protrusions of the bottom cover disposed perpendicular to the side wall are to be received by the recesses of the top cover.

15. The apparatus of claim 9, wherein the computing device is an all-in-one (AIO) computing device.

16. The apparatus of claim 9, wherein reception of the protrusions at the recesses increase shear load capacity between the first portion and the second portion.

17. The apparatus of claim 9, wherein the protrusions and recesses are a castle-lock structure.

18. A computing device, comprising:
protrusions at a side wall of a first portion of the computing device, the protrusions formed as a pattern along the periphery of the first portion; and
recesses of a second portion of the computing device, the recesses to receive the protrusion of the first portion.

19. The computing device of claim 18, comprising:
two 90 degree angle transitions of each protrusion; and
two 90 degree angle transitions of each recess.

20. The slide reduction mechanism of claim 18, wherein the protrusions is disposed perpendicular to the side wall.

21. The computing device of claim 18, wherein the first portion is a bottom cover of the computing device and the second portion is a top cover of the computing device.

22. The computing device of claim 21, wherein the protrusions received by the recess are to increase shear load capacity between the bottom cover and the top cover.

23. The computing device of claim 18, wherein the computing device is an all-in-one (AIO) computing device.

24. The computing device of claim 23, wherein the first portion is a bottom cover of the computing device and the second portion is a top cover of the computing device, wherein the top cover is a sub-frame of the AIO computing device, wherein the sub-frame is to at least partially house a display of the computing device.
